(19) United States
(12) Patent Application Publication
(10) Pub. No.: US 2026/0245863 A1
(43) Pub. Date: Aug. 20, 2026

(54) ALKALINE DRY-CELL BATTERY

(71) Applicant: Panasonic Intellectual Property Management Co., Ltd., Osaka (JP)

(72) Inventors: KEISUKE TAKAHASHI, Osaka (JP); SATOSHI FUJIYOSHI, Osaka (JP); JUN NUNOME, Kyoto (JP)

(21) Appl. No.: 19/153,878

(22) PCT Filed: Dec. 6, 2023
(86) PCT No.: PCT/JP2023/043640

§ 371 Date: Aug. 5, 2025

(30) Foreign Application Priority Data
Feb. 14, 2023 (JP) 2023-021095

(51) Int. Cl. H01M 4/06; H01M 4/02; H01M 6/06; H01M 50/489

(52) U.S. Cl. CPC H01M 4/06; H01M 6/06; H01M 50/489; H01M 2004/023; H01M 2004/027; H01M 2004/028

(57) ABSTRACT

An alkaline dry battery includes a positive electrode which has a cylindrical shape and which is disposed in a battery case, a gelled negative electrode containing zinc powder and filled in a hollow portion of the positive electrode, and a separator disposed between the positive electrode and the negative electrode. The separator has a total thickness within a range of 160 to 300 μm. The negative electrode contains a sulfate salt within a range of 0.01 to 0.5% by mass with respect to mass of the negative electrode in terms of sulfate ions.

### BACKGROUND

### 1. Technical Field

The present disclosure relates to an alkaline dry battery.

### 2. Description of the Related Art

An alkaline dry battery (e.g., an alkaline manganese dry battery) is widely used because the alkaline dry battery has a larger battery capacity than a manganese dry battery and can extract a larger current. The alkaline dry battery usually includes a positive electrode, a negative electrode, a separator disposed between the positive electrode and the negative electrode, and an alkaline electrolytic solution. The positive electrode contains manganese dioxide as a positive electrode active material. Various proposals have been made to improve the characteristics of the alkaline dry battery.

Patent Literature 1 discloses an alkaline battery including a gelled negative electrode mixture, in which a sealing gasket includes a boss portion, a plate-shaped intermediate partition wall portion formed around the boss portion, and a bent portion formed so as to be bent in a U shape toward a positive electrode mixture on an outer peripheral side of the intermediate partition wall portion, and an opening end edge of a separator close to the negative electrode is disposed so as to be separated from the bent portion and abut on an inner surface of the intermediate partition wall portion. When an imaginary line parallel to the battery center axis line direction is assumed at the inner peripheral edge portion of the opening-side end surface of the positive electrode mixture disposed closest to the opening, the distance from the inner peripheral edge portion to the sealing gasket along the imaginary line is 1.0 mm or more and 2.75 mm or less. The separator is formed to have a thickness of 230 μm or more and 575 μm or less by winding a separator material two times or more and five times or less, the separator material being made of vinylon fibers, rayon fibers, polyvinyl alcohol fibers, and pulp and having a liquid retention rate of 250% or more and 350% or less. The amount of the zinc powder in the gelled negative electrode mixture is 2.00 g or more and 3.81 g or less. According to Patent Literature 1, this configuration makes it possible to provide an alkaline battery having excellent impact resistance despite having suitable discharge performance.

Patent Literature 2 proposes that, in an alkaline battery including a positive electrode, a negative electrode containing zinc, and an electrolytic solution, a calcium compound or a sulfuric acid compound is added to at least one of the positive electrode, the negative electrode, or the electrolytic solution to prevent a decrease in discharge voltage under a heavy load discharge condition. According to Patent Literature 2, since sulfate ions migrate toward the negative electrode together with H₂O during discharge, the volume of the electrolytic solution in the vicinity of the negative electrode is sufficient even under the heavy load discharge conditions, and a decrease in discharge voltage is suppressed.

### CITATION LIST

### Patent Literature

Patent Literature 1: Japanese Patent Publication No. 5366490
Patent Literature 2: Unexamined Japanese Patent Publication No. 2001-297776

### SUMMARY

From the viewpoint of increasing the discharge capacity of the battery, it is conceivable to decrease the total thickness of the separator and instead increase the loading amount of the positive electrode mixture or the negative electrode mixture. However, when the thickness of the separator is decreased, zinc oxide is deposited inside the separator during medium load intermittent discharge, and an internal short circuit is likely to occur.

One aspect of the present disclosure relates to an alkaline dry battery including: a cylindrical positive electrode disposed in a battery case; a gelled negative electrode containing a zinc powder, the gelled negative electrode being filled in a hollow portion of the positive electrode; and a separator disposed between the positive electrode and the negative electrode, wherein the separator has a total thickness within a range of 160 to 300 μm, and the negative electrode contains a sulfate salt within a range of 0.01 to 0.5% by mass in terms of sulfate ions relative to a mass of the negative electrode.

In the present disclosure, it is possible to suppress occurrence of an internal short circuit during medium load intermittent discharge.

### BRIEF DESCRIPTION OF DRAWINGS

FIG. 1 is a partially exploded cross-sectional view illustrating an example of an alkaline dry battery according to an embodiment.

### DESCRIPTION OF EMBODIMENT

Hereinafter, an embodiment according to the present disclosure will be described with examples, but the present disclosure is not limited to the examples described below. In the following description, specific numerical values and materials may be exemplified, but other numerical values and other materials may be applied as long as the invention according to the present disclosure can be implemented. In the present specification, the expression “numerical value A to numerical value B” includes the numerical value A and the numerical value B, and can be read as “numerical value A or more and numerical value B or less”. In the following description, when lower limits and upper limits of numerical values relating to specific physical properties and conditions are exemplified, any of the exemplified lower limits and any of the exemplified upper limits can be arbitrarily combined as long as the lower limit is not equal to or greater than the upper limit. When a plurality of materials are exemplified, one of them may be selected and used alone, or two or more thereof may be used in combination.

Furthermore, the present disclosure encompasses a combination of matters recited in two or more claims arbitrarily selected from a plurality of claims recited in the claims. That is, the matters described in two or more claims arbitrarily selected from a plurality of claims recited in the claims can be combined as long as no technical contradiction arises.

### (Alkaline Dry Battery)

The alkaline dry battery according to the present embodiment is an alkaline dry battery including a cylindrical positive electrode disposed in a battery case, a gelled negative electrode containing zinc powder and filled in a hollow portion of the positive electrode, and a separator disposed between the positive electrode and the negative electrode. The zinc powder includes zinc alloy powder. The separator has a total thickness within a range of 160 to 300 μm. The negative electrode contains a sulfate salt within a range of 0.01 to 0.5% by mass with respect to the mass of the negative electrode in terms of sulfate ions.

Since the sulfate salt is contained in the negative electrode, an internal short circuit due to precipitation of zinc oxide in a use environment of medium load intermittent discharge is suppressed. Therefore, by using a thin separator having a total thickness of 300 μm or less, an alkaline dry battery which has excellent medium load intermittent discharge characteristics and in which a high discharge capacity is maintained can be realized.

The precipitation of zinc oxide is considered to be caused by the phenomenon that OH-ions in the electrolytic solution in the negative electrode are consumed by discharge, the pH of the electrolytic solution is lowered, and the pH of the electrolytic solution is changed toward neutrality, whereby the solubility of zinc ions dissolved in the electrolytic solution is lowered. In particular, in a use environment in which discharge is intermittently repeated for about one hour per day at a medium load of a current of about 250 mA to 500 mA, a local decrease in pH of the electrolytic solution is remarkable, and the electrolytic solution is likely to be locally neutralized. As a result, an internal short circuit due to precipitation of zinc oxide is likely to occur.

In an undischarged alkaline dry battery, the sulfate salt added to the negative electrode is hardly dissolved in the electrolytic solution because the electrolytic solution is strongly alkaline. However, when the pH of the electrolytic solution in the negative electrode decreases with discharge, the sulfate salt is easily dissolved, and the pH of the electrolytic solution further decreases to the acidic side. On the other hand, the solubility of zinc ions is lowest in a neutral state, and zinc ions are easily dissolved in an alkaline state and an acidic state. Therefore, when the sulfate salt is dissolved in the middle of the medium load intermittent discharge, the pH of the electrolytic solution is changed from neutrality to acidic side, whereby zinc ions are easily dissolved, and precipitation of zinc oxide is suppressed.

Note that, under a discharge condition of a heavy load (for example, about 1 A), the discharge voltage of the alkaline dry battery usually decreases before the electrolytic solution becomes neutral, and the alkaline dry battery reaches the end of its life. Therefore, under such a condition, the problem of an internal short circuit due to precipitation of zinc oxide hardly occurs.

Since the content of the sulfate salt contained in the negative electrode is 0.01% by mass or more with respect to the mass of the negative electrode in terms of sulfate ions, the effect of suppressing an internal short circuit due to precipitation of zinc oxide can be sufficiently obtained. On the other hand, when the content of the sulfate salt is excessive, unevenness in the distribution of the sulfate salt inside the negative electrode increases, and thus unevenness in the pH of the electrolytic solution inside the negative electrode during discharge increases, which may rather promote an internal short circuit. From the viewpoint of suppressing pH unevenness of the electrolytic solution, the content of the sulfate salt may be 0.5% by mass or less with respect to the mass of the negative electrode in terms of sulfate ions. The content of the sulfate salt may be 0.01% by mass or more and 0.5% by mass or less, preferably 0.05% by mass or more and 0.3% by mass or less, and more preferably 0.08% by mass or more and 0.2% by mass or less.

Here, the content of the sulfate salt in terms of sulfate ions means the ratio of the mass of sulfate ions (SO₄²⁻) out of cations and sulfate ions constituting the sulfate salt contained in the negative electrode to the total mass of the negative electrode. The content of the sulfate salt is determined by disassembling an undischarged alkaline dry battery, collecting at least a part (for example, 80% or more) of the negative electrode, measuring the mass thereof, exposing the collected negative electrode to pure water to dissolve the sulfate salt in the pure water, and performing ion chromatography. The content of the sulfate salt in terms of sulfate ions is determined by quantifying SO₄²⁻ by ion chromatography and calculating the mass occupied in the negative electrode.

In the case where the content of the sulfate salt is within the above range, since the total thickness of the separator is 160 μm or more, an internal short circuit due to precipitation of zinc oxide can be sufficiently suppressed. On the other hand, as the thickness of the separator increases, the internal short circuit is more easily suppressed, but the filling volume of the active material decreases, and discharge performance decreases. Since the total thickness of the separator is 300 μm or less, it is possible to realize an alkaline dry battery which has high discharge performance and in which an internal short circuit is suppressed even when the alkaline dry battery is used in medium load intermittent discharge. The total thickness of the separator may be 160 μm or more and 300 μm or less, preferably 160 μm or more and 260 μm or less, and more preferably 180 μm or more and 240 μm or less.

The separator can be formed so as to have a desired total thickness by stacking a plurality of separators each having a predetermined thickness, or by stacking a separator having a predetermined thickness while winding the separator a plurality of times. The total thickness of the separator is an average value of thicknesses at three angularly equivalent points (e.g., three points adjacent to each other at a circumferential angle of 120°) of the cylindrical separator. In addition, the total thickness of the separator means the thickness in a state where the electrolytic solution is absorbed in the battery.

The total thickness T of the separator is determined by obtaining a cross section of the alkaline dry battery after production by CT scanning and measuring the distance between the positive electrode and the negative electrode. The distance from the tip of the positive electrode terminal to the tip of the negative electrode terminal of the battery is defined as the total height. The distance between the positive and negative electrodes in a cross section at a height of ½ of the total height is measured at three angularly equivalent points (e.g., three points adjacent to each other at a circumferential angle of 120°), and the average value at the three points is defined as the total thickness T of the separator.

The total air permeability A of the separator is, for example, 0.1 to 3.0 cc/cm²·s, and more preferably within the range of 0.2 to 1.5 cc/cm²·s. The air permeability is measured in accordance with the Frazier air permeability tester method specified in JIS L 1096:2010 for a separator obtained by disassembling and taking the separator a manufactured alkaline dry battery, washing the separator with a KOH aqueous solution having a concentration of 34% by mass, and allowing the separator to stand and dry under a reduced pressure condition at 20° C. for one day. When a plurality of separators of the same type are stacked and used, the total air permeability A can be obtained by dividing the air permeability of one separator measured without stacking by the number of stacked separators. When different types of separators are stacked and used, the air permeability of the stacked separators is measured to determine the total air permeability A.

The cation constituting the sulfate salt is not particularly limited as long as it does not hinder the discharge reaction of the battery. The sulfate salt may be a salt of a metal cation and a sulfate ion. The sulfate salt preferably contains at least one selected from the group consisting of potassium sulfate salt, sodium sulfate salt, aluminum sulfate salt, aluminum potassium sulfate salt, calcium sulfate salt, zinc sulfate salt, and lithium sulfate salt, and also preferably contains a hydrate thereof, from the viewpoint of a large effect of lowering the pH after dissolution.

An alkaline dry battery according to the present disclosure includes a positive electrode, a negative electrode, a separator, and an electrolytic solution, and optionally includes other components. Examples of components of the alkaline dry battery according to the present disclosure will be described below.

### (Positive Electrode)

The positive electrode contains manganese dioxide as a positive electrode active material. The positive electrode usually contains a positive electrode active material and a conductive material, and further contains a binder as necessary. The positive electrode may be formed by pressure molding the positive electrode mixture (e.g., positive electrode pellet) into a cylindrical body. The positive electrode mixture contains, for example, a positive electrode active material, a conductive material, and an alkaline electrolytic solution, and further contains a binder as necessary. The cylindrical body may be pressed so as to come into close contact with the inner wall of the case body after being accommodated in the case body.

A preferred example of manganese dioxide as the positive electrode active material is electrolytic manganese dioxide, but natural manganese dioxide or chemical manganese dioxide may also be used. Examples of the crystal structure of manganese dioxide include α type, β type, γ type, δ type, ε type, η type, λ type, and ramsdellite type.

The average particle diameter (D50) of the powder of manganese dioxide may be, for example, within the range of 25 μm to 60 μm from the viewpoint of easily ensuring the filling property of the positive electrode and the diffusiveness of the electrolytic solution in the positive electrode.

From the viewpoint of formability and suppression of expansion of the positive electrode, the BET specific surface area of manganese dioxide may be, for example, within the range of 20 m²/g to 50 m²/g. The BET specific surface area can be measured, for example, by using a specific surface area measuring device based on a nitrogen adsorption method.

The conductive material may be a conductive carbon material. Examples of the conductive carbon material include carbon black (such as acetylene black) and graphite. Examples of the graphite include natural graphite and artificial graphite. The conductive material may be in the form of powder. An average particle diameter (D50) of the conductive material may be within a range of 3 μm to 20 μm. The content of the conductive material in the positive electrode may be within the range of 3 parts by mass to 10 parts by mass (for example, within the range of 5 parts by mass to 9 parts by mass) with respect to 100 parts by mass of manganese dioxide.

In order to absorb hydrogen generated inside the battery, a silver compound may be added to the positive electrode. Examples of the silver compound include silver oxide (e.g., Ag₂O, AgO, and Ag₂O₃), and silver-nickel composite oxide (e.g., AgNiO₂).

### (Negative Electrode)

The negative electrode contains a zinc alloy powder as a negative electrode active material. From the viewpoint of corrosion resistance, the zinc alloy may contain at least one selected from the group consisting of indium, bismuth, and aluminum. The indium content in the zinc alloy may be, for example, within the range of 0.01% by mass to 0.1% by mass. The bismuth content in the zinc alloy may be, for example, within the range of 0.003% by mass to 0.02% by mass. The aluminum content in the zinc alloy may be, for example, within the range of 0.001% by mass to 0.03% by mass. The content of elements other than zinc in the zinc alloy may be within a range of 0.025% by mass to 0.08% by mass from the viewpoint of the corrosion resistance.

The average particle diameter (D50) of the zinc alloy powder may be within the range of 100 μm to 200 μm (for example, within the range of 110 μm to 160 μm) from the viewpoint of the filling property of the negative electrode and the diffusiveness of the electrolytic solution in the negative electrode. In the present specification, the average particle diameter is a median diameter (D50) at which a cumulative volume reaches 50% in a volume-based particle size distribution. The median diameter is determined using, for example, a laser diffraction/scattering particle size distribution analyzer.

The negative electrode includes a zinc alloy powder, a gelling agent, a surfactant, a sulfate salt, and an electrolytic solution. The negative electrode can be formed by mixing the zinc alloy powder, the gelling agent, the surfactant, the sulfate salt, and the electrolytic solution. From the viewpoint of more uniformly dispersing the additive (e.g., gelling agent and surfactant) in the negative electrode, the additive is preferably added in advance to the electrolytic solution used for producing the negative electrode. As the electrolytic solution, an electrolytic solution (e.g., alkaline electrolytic solution) described later can be used.

In order to improve the corrosion resistance, a compound containing a metal having a high hydrogen overvoltage, such as indium or bismuth, may be appropriately added to the negative electrode.

### (Negative Electrode Current Collector)

The alkaline dry battery of the present disclosure may include a negative electrode current collector inserted into the negative electrode. The material of the negative electrode current collector may be a metal (i.e., a single metal or an alloy). The material of the negative electrode current collector preferably contains copper, and may be an alloy containing copper and zinc (for example, brass). The negative electrode current collector may be subjected to a plating treatment such as tin plating, if necessary.

### (Separator)

As the separator, a non-woven fabric mainly composed of fibers or a microporous film made of a resin is used. Examples of the material of the fiber include cellulose and polyvinyl alcohol. The non-woven fabric may be formed by mixing cellulose fibers and polyvinyl alcohol fibers, or may be formed by mixing rayon fibers and polyvinyl alcohol fibers. Examples of the material of the microporous film include resins such as cellophane and polyolefin. The thickness (more specifically, total thickness) of the separator is within the range of 160 μm to 300 μm. When the separator is thin, a plurality of separators may be stacked and adjusted to the above thickness.

### (Electrolytic Solution)

As the electrolytic solution (e.g., alkaline electrolytic solution), for example, an alkaline aqueous solution containing potassium hydroxide is used. The concentration of potassium hydroxide in the alkaline electrolytic solution is preferably within the range of 30 to 50% by mass (for example, within the range of 30 to 40% by mass). The alkaline electrolytic solution may contain zinc oxide.

The alkaline electrolytic solution may contain a surfactant. By using the surfactant, the dispersibility of the negative electrode active material particles can be enhanced. As the surfactant, those exemplified for the negative electrode can be used. The content of the surfactant in the alkaline electrolytic solution is usually within the range of 0.001 to 0.5% by mass (for example, within the range of 0.002 to 0.2% by mass).

### (Battery Housing)

The battery housing is not particularly limited, and a housing corresponding to the shape of the battery may be used. The shape of the alkaline dry battery according to the exemplary embodiment is not particularly limited, and may be a cylindrical shape or a coin shape (including a button shape). The battery housing usually includes a battery case, a negative electrode terminal plate, and a gasket. As the battery case, for example, a bottomed cylindrical metal case is used. For example, a nickel-plated steel plate is used for the metal case. In order to decrease the contact resistance between the positive electrode and the battery case, the inner surface of the battery case may be coated with a carbon coating. The negative electrode terminal plate can be formed of the same material as that of the metal case, and can be formed of, for example, a nickel-plated steel plate.

Examples of the material of the gasket include polyamide, polyethylene, polypropylene, polyphenyl ether, and polyphenylene ether. From the viewpoint of the corrosion resistance to an alkaline electrolytic solution, the material of the gasket is preferably polyamide-6,6, polyamide-6,10, polyamide-6,12, or polypropylene. The gasket usually has an annular thin portion.

Hereinafter, an example of an embodiment according to the present disclosure will be specifically described with reference to the drawing. The constituent elements described above can be applied to the constituent elements of the exemplary alkaline dry battery described below. In addition, the constituent elements of the exemplary alkaline dry battery described below can be changed based on the above description. Further, the matters described below may be applied to the above-described embodiment.

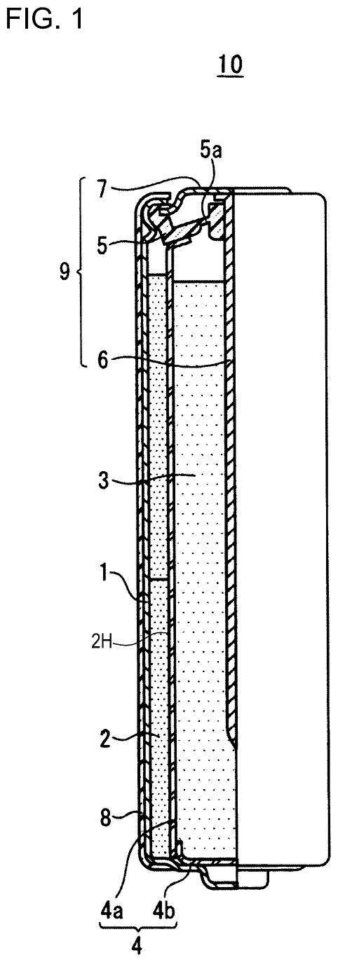

FIG. 1 is a partially exploded cross-sectional view of an alkaline dry battery 10 having an inside-out structure according to an embodiment of the present disclosure. The cylindrical alkaline dry battery 10 includes a battery case 1, and a positive electrode 2, a negative electrode 3 (e.g., gelled negative electrode), a separator 4, and an electrolytic solution (not shown) disposed in the battery case 1.

The battery case 1 is a bottomed cylindrical case and functions as a positive electrode terminal. The positive electrode 2 has a cylindrical shape and is disposed so as to be in contact with the inner wall of the battery case 1. The negative electrode 3 is disposed in the hollow portion 2H of the positive electrode 2. The separator 4 is disposed between the positive electrode 2 and the negative electrode 3. The negative electrode has the features described above.

The separator 4 includes a cylindrical separator 4a and a bottom paper 4b. The separator 4a is disposed along the inner surface of the hollow portion 2H of the positive electrode 2, and separates the positive electrode 2 and the negative electrode 3 from each other. The bottom paper 4b is disposed at the bottom of the hollow portion 2H of the positive electrode 2, and separates the negative electrode 3 from the battery case 1.

The opening of the battery case 1 is sealed by a sealing unit 9. The sealing unit 9 includes a gasket 5, a negative electrode current collector 6, and a negative electrode terminal plate 7 functioning as a negative electrode terminal. The negative electrode current collector 6 has a nail shape having a head portion and a body portion. The negative electrode current collector 6 contains, for example, copper, and may be made of an alloy containing copper and zinc, such as brass. The negative electrode current collector 6 may be subjected to a plating treatment such as tin plating as necessary. The body portion of the negative electrode current collector 6 is inserted into a through hole provided in a central portion of the gasket 5, and is inserted into the negative electrode 3. The head portion of the negative electrode current collector 6 is welded to a central flat portion of the negative electrode terminal plate 7. The gasket 5 has an annular thin portion 5a.

The opening end of the battery case is swaged to the peripheral edge (i.e., the flange) of the negative electrode terminal plate 7 via the peripheral edge of the gasket 5. The outer surface of the battery case 1 is covered with an exterior label 8. The battery case 1, the gasket 5, and the negative electrode terminal plate 7 constitute a battery housing. The positive electrode 2, the negative electrode 3, the separator 4, and an alkaline electrolytic solution (not shown) are disposed in a battery housing.

A method for assembling the alkaline dry battery 10 is not particularly limited, and a conventional technique can be applied as necessary.

### EXAMPLES

The alkaline dry battery of the present disclosure will be described in more detail with reference to Examples.

### Inventive Example 1

### (1) Preparation of Electrolytic Solution (Alkaline Electrolytic Solution)

As an alkaline electrolytic solution, an alkaline aqueous solution containing potassium hydroxide (concentration: 33% by mass) and zinc oxide (concentration: 2% by mass) was prepared.

### (2) Preparation of Positive Electrode

Manganese dioxide (i.e., an example of the positive electrode active material) and graphite (i.e., an example of the conductive material) were mixed to obtain a mixture. They were mixed at a mass ratio of manganese dioxide:graphite=100:6. As the manganese dioxide, powder of electrolytic manganese dioxide (average particle diameter (D50): 40 μm) was used. As the graphite, graphite powder (average particle diameter (D50): 8 μm) was used.

The electrolytic solution was added to the mixture, and the mixture was sufficiently stirred and then compression-molded into flakes to obtain a positive electrode mixture. The mass ratio between the mixture and the electrolytic solution was set to mixture:electrolytic solution=100:2. As the electrolytic solution, the same electrolytic solution as the alkaline electrolytic solution prepared in the section (1) was used.

Next, the flaky positive electrode mixture was pulverized into granules, and the granules were classified with a 10 to 100 mesh sieve to obtain granules. The obtained granules were press-molded into a hollow cylindrical shape (height: 10.8 mm) to obtain a positive electrode pellet (mass: 2.9 g).

### (3) Preparation of Negative Electrode

The zinc alloy powder, the surfactant, the gelling agent, the sulfate salt, and the electrolytic solution were mixed to obtain a gelled negative electrode. The materials other than the zinc alloy powder and the sulfate salt were mixed at a mass ratio of surfactant:gelling agent:electrolytic solution=0.005:2.4:100. As the electrolytic solution, the same electrolytic solution as the alkaline electrolytic solution prepared in the above section (1) was used. Potassium sulfate salt (K₂SO₄) was used as the sulfate salt, and the content thereof was 0.01% by mass with respect to the entire negative electrode in terms of sulfate ions. The content of the zinc alloy powder and the sulfate salt was 66% by mass with respect to the entire negative electrode. As the negative electrode active material, a zinc alloy powder containing 0.02% by mass of indium, 0.01% by mass of bismuth, and 0.005% by mass of aluminum was used. As the surfactant, an anionic surfactant was used. As the gelling agent, a mixture of a crosslinked polyacrylic acid and a crosslinked polyacrylic acid partial sodium salt was used.

### (4) Assembly of Alkaline Dry Battery

An alkaline dry battery was assembled by the following method using the above components. A procedure for assembling the battery will be described with reference to FIG. 1.

First, a coating agent (product name: Varniphite) manufactured by Nippon Graphite Industries, Ltd. was applied to the inner surface of a bottomed cylindrical case made of a nickel-plated steel sheet to form a carbon coating having a thickness of about 10 μm, thereby obtaining a battery case 1. Next, four positive electrode pellets were vertically inserted into the battery case 1 and then pressurized to form the positive electrode 2 in close contact with the inner wall of the battery case 1. After a bottomed cylindrical separator 4 was disposed inside the positive electrode 2, the alkaline electrolytic solution prepared in the above section (1) was injected. In this way, the separator 4 was impregnated with the alkaline electrolytic solution. The battery case 1 was left in this state for a predetermined time to allow the alkaline electrolytic solution to permeate from the separator 4 into the positive electrode 2. Thereafter, 6.4 g of the gelled negative electrode 3 was filled in the separator 4.

The separator 4 was formed using a cylindrical separator 4a and a bottom paper 4b. As the cylindrical separator 4a and the bottom paper 4b, a non-woven fabric sheet obtained by mixing rayon fibers and polyvinyl alcohol fibers (mass ratio: 1:1) as main components was used.

The negative electrode current collector 6 was formed by pressing general brass into a nail shape and then plating the surface with tin. The head of the negative electrode current collector 6 was electrically welded to a negative electrode terminal plate 7 made of a nickel-plated steel plate. Thereafter, the body portion of the negative electrode current collector 6 was press-fitted into the through hole at the center of the gasket 5 containing polyamide-6,10 as a main component. In this way, a sealing unit 9 including the gasket 5, the negative electrode current collector 6, and the negative electrode terminal plate 7 was produced.

Next, the sealing unit 9 was disposed at the opening of battery case 1. At this time, the body portion of the negative electrode current collector 6 was inserted into the negative electrode 3. Next, the opening end of the battery case 1 was swaged to the peripheral edge of the negative electrode terminal plate 7 so as to sandwich the gasket 5, thereby sealing the opening of the battery case 1. In this way, the positive electrode 2, the negative electrode 3, the separator 4, and the alkaline electrolytic solution (not shown) were disposed in the battery housing.

Next, the outer surface of the battery case 1 was covered with the exterior label 8. In this way, an alkaline dry battery A1 according to the inventive example 1 was produced.

For the battery A1, a cross section at a height of ½ of the height from the positive electrode terminal at the bottom of the battery case 1 to the negative electrode terminal plate 7 was obtained by CT scanning, and the total thickness of the separator was determined by the method described above. The total thickness of the separator was 160 μm.

### (5) Evaluation

The battery was connected to a 3.9Ω resistor via a switch, and the switch was turned on at a duty ratio of one hour per day to perform intermittent discharge. Specifically, in an environment of 20±1° C., a cycle of discharging for 1 hour and then pausing for 23 hours was repeated. The above discharge cycle was repeated until the battery voltage reached 0.8 V.

For ten alkaline dry batteries (N=10), the total discharge time from the start of discharge until the battery voltage reached 0.8 V or less (that is, the total period during which the switch was on) was evaluated as the duration. When the duration was less than 8 hours, it was determined that an internal short circuit occurred during the discharge, and the number n of batteries having the duration of less than 8 hours was obtained.

### Inventive Example 2 to 8 and Comparative Examples 1 to 10

At least one of the thickness of the separator or the content ratio of the sulfate salt contained in the negative electrode was changed from the inventive example 1. Except for the above change, alkaline dry batteries A2 to A8 and B1 to B10 according to the inventive example 2 to 8 and the comparative examples 1 to 10 were produced and evaluated in the same manner as in the inventive example 1.

In the comparative examples 1, 4, 7, and 10, alkaline dry batteries were produced without adding a sulfate salt to the negative electrode to obtain batteries B1, B4, B7, and B10, respectively.

For each of the batteries A2 to A8 and B1 to B10, a cross section at a height of ½ of the height from the positive electrode terminal at the bottom of the battery case 1 to the negative electrode terminal plate 7 was obtained by CT scanning, and the total thickness of the separator was determined by the method described above. The results are shown in Table 1.

Table 1 shows the evaluation results of the duration. In Table 1, for each of the batteries A1 to A8 and B1 to B10, the ratio n/N of the batteries having the duration of less than 8 hours is shown as the occurrence ratio of the internal short circuit. Table 1 also shows the total thickness of the separator and the content of the sulfate salt in the negative electrode of each of the batteries A1 to A8 and B1 to B10, together with the internal short-circuit occurrence ratio n/N. The content of the sulfate salt represents the percentage of the mass of sulfate ions in the sulfate salt with respect to the mass of the entire negative electrode.

As shown in Table 1, in the case of the battery in which the total thickness of the separator is 160 μm or more and the content of the sulfate salt is within the range of 0.01 to 0.5% by mass in terms of sulfate ions, the internal short circuit is suppressed.

In the battery B1, since the total thickness of the separator is as thin as 150 μm and the sulfate salt is not added to the negative electrode, the occurrence ratio of the internal short circuit is high. In contrast, in the batteries B2 and B3, the addition of the sulfate salt to the negative electrode decreases the occurrence ratio of the internal short circuit as compared with the battery B1, but the effect of suppressing the internal short circuit is not sufficient.

In the battery B5, although the occurrence ratio of the internal short circuit is lower than that of the battery B4 to which the sulfate salt is not added, the content of the sulfate salt is as low as 0.005% by mass in terms of sulfate ions, and the internal short circuit cannot be sufficiently suppressed. On the other hand, in the battery B6, the content of the sulfate salt was 0.7% by mass in terms of sulfate ions, which was excessive, so that the occurrence ratio of the internal short circuit was higher than that of the battery A4. It is considered that this is because the unevenness of the distribution of the sulfate salt inside the negative electrode increases with the increase in the sulfate salt content, and the unevenness of the pH of the electrolytic solution inside the negative electrode increases, and as a result, the internal short circuit is rather promoted.

In the battery B10, since the total thickness of the separators was 320 μm, which was sufficiently large, the internal short circuit could be suppressed without adding a sulfate salt to the negative electrode. However, since the total thickness of the separator is large, the filling amount of the negative electrode active material is small, and the discharge capacity of the battery is decreased. The batteries A1 to A8 in which the total thickness of the separator is within the range of 160 to 300 μm and the content of the sulfate salt is within the range of 0.01 to 0.5% by mass in terms of sulfate ions are preferable from the viewpoint that the discharge capacity is high and an internal short circuit can be suppressed.

TABLE 1

| | Separator | Sulfate Salt | Internal |
|---|---|---|---|
| | Total | Content | Short Circuit |
| | Thickness | Ratio | Occurrence |
| Battery | (μm) | (% by mass) | Ratio |
| B1 | 150 | 0 | 8/10 |
| B2 | 150 | 0.01 | 4/10 |
| B3 | 150 | 0.50 | 2/10 |
| B4 | 160 | 0 | 6/10 |
| B5 | 160 | 0.005 | 3/10 |
| A1 | 160 | 0.01 | 0/10 |
| A2 | 160 | 0.1 | 0/10 |
| A3 | 160 | 0.3 | 0/10 |
| A4 | 160 | 0.5 | 0/10 |
| B6 | 160 | 0.7 | 2/10 |
| A5 | 200 | 0.01 | 0/10 |
| A6 | 260 | 0.01 | 0/10 |
| B7 | 300 | 0 | 2/10 |
| B8 | 300 | 0.005 | 2/10 |
| A7 | 300 | 0.01 | 0/10 |
| A8 | 300 | 0.5 | 0/10 |
| B9 | 300 | 0.7 | 2/10 |
| B10 | 320 | 0 | 0/10 |

### Inventive Examples 9 to 17

In the above section (3) of the preparation of the negative electrode, the sulfate salt added to the negative electrode was changed from potassium sulfate salt (K₂SO₄) used in the inventive example 1. Alkaline dry batteries A9 to A17 according to the inventive examples 9 to 17 were produced and evaluated in the same manner as in the inventive example 1, except for the above change.

Table 2 shows the evaluation results of the batteries A9 to A17 together with the evaluation results of the batteries A1, A5, and A7. In Table 2, for each battery, the ratio n/N of the batteries having a duration of less than 8 hours is shown as the occurrence ratio of internal short circuits. In Table 2, the total thickness of the separator and the type of sulfate salt contained in the negative electrode in each battery are shown together with the occurrence ratio n/N of the internal short circuit. The content of the sulfate salt in each battery shown in Table 2 is 0.01% by mass with respect to the mass of the entire negative electrode in terms of sulfate ions.

TABLE 2

| | Separator | | Internal |
|---|---|---|---|
| | Total | | short circuit |
| | Thickness | | Occurrence |
| Battery | (μm) | Sulfate Salt | Ratio |
| A1 | 160 | K₂SO₄ | 0/10 |
| A5 | 200 | K₂SO₄ | 0/10 |
| A7 | 300 | K₂SO₄ | 0/10 |
| A9 | 160 | Na₂SO₄ | 0/10 |
| A10 | 160 | Na₂SO₄•7H₂O | 0/10 |
| A11 | 160 | Al₂(SO₄)₃•16H₂O | 0/10 |
| A12 | 160 | KAl(SO₄)₂ | 0/10 |
| A13 | 160 | KAl(SO₄)₂•12H₂O | 0/10 |
| A14 | 160 | CaSO₄ | 0/10 |
| A15 | 160 | ZnSO₄ | 0/10 |
| A16 | 160 | ZnSO₄•7H₂O | 0/10 |
| A17 | 160 | Li₂SO₄•H₂O | 0/10 |

As shown in Table 2, in the batteries A9 to A17, the internal short circuit could be suppressed regardless of the type of the sulfate salt added to the negative electrode.

### INDUSTRIAL APPLICABILITY

The present disclosure is applicable to alkaline dry batteries.

### REFERENCE SIGNS LIST

1 battery case
2 positive electrode
2H hollow portion
3 negative electrode
4 separator
4a cylindrical separator
4b bottom paper
5 gasket
5a thin portion
6 negative electrode current collector
7 negative electrode terminal plate
8 exterior label
9 sealing unit
10 alkaline dry battery

1. An alkaline dry battery, comprising:
a positive electrode having a cylindrical shape; the positive electrode including a hollow portion, the positive electrode being disposed in a battery case;
a negative electrode which is gelled; the negative electrode containing zinc powder, the negative electrode being filled in the hollow portion of the positive electrode; and
a separator disposed between the positive electrode and the negative electrode,
wherein
the separator has a total thickness within a range of 160 to 300 μm, and
the negative electrode contains a sulfate salt within a range of 0.01 to 0.5% by mass with respect to mass of the negative electrode in terms of sulfate ions.

2. The alkaline dry battery according to claim 1, wherein
the sulfate salt includes at least one selected from the group consisting of potassium sulfate salt, sodium sulfate salt, aluminum sulfate salt, aluminum potassium sulfate salt, calcium sulfate salt, zinc sulfate salt, lithium sulfate salt, and hydrates thereof.
